(19) United States
(12) Patent Application Publication
(10) Pub. No.: US 2010/0028073 A1
(43) Pub. Date: Feb. 4, 2010

(54) Apparatus and method

(76) Inventor: Paul Bedding, Essex (GB)

Correspondence Address: WILLIAM D. HALL, 10850 STANMORE DR, POTOMAC, MD, 20854, US

(21) Appl. No.: 12/311,723

(22) PCT Filed: Oct. 4, 2007
(86) PCT No.: PCT/GB2007/003750

§ 371 Date: May 21, 2009

(30) Foreign Application Priority Data
Oct. 10, 2006 (GB) 06200224.4
Mar. 31, 2007 (GB) 0706329.0

(51) Int. Cl. B42F 13/16

(52) U.S. Cl. 402/68; 412/1

(57) ABSTRACT

A ring binding apparatus comprises a channel-form guide (2), a slide (6) guided by the guide (2) for linearly slidingly guided movement relative to the guide (2) between a first position and a second position, a detent arrangement (42,44) whereby the slide (6) is releasably retained in the second position, and loop-form elements (30) receivable independently of each other between the guide (2) and the slide (6) in the first position and, when the slide (6) is in the second position, locatingly engaged by the slide (6) in positions transverse to the aforesaid linearly slidingly guided movement and parallel to each other. The elements (30) are removable independently of each other following return of the slide (6) to the first position.

This invention relates to a ring binding apparatus.

Since the introduction of suspended presentation portfolios, manufacturers have been providing standard stationery ring mechanisms to bind the presentation material. Although these work for some time, gradually the rings become weak and eventually the presentation material starts to fall off the rings. Obviously, this can impair the user's presentation and damage valuable artwork. The difficulties are more evident with desktop presentation portfolios that stand with the presentation material hanging vertically from the ring mechanism. In particular, those desktop presentation portfolios are restricted to carrying an undesirably limited amount of weight of presentation material, since the ring mechanism cannot carry a greater weight or it will open or even break.

Conventional ring binders are of course designed as a solution for filing and the snap-open action allows fast insertion and removal of material. This is not normally necessary with a presentation portfolio, as the user would seldom change the contents once having loaded the portfolio. Moreover, with the snap-open action of the known rings the join between the ring parts often prevents easy turning of at least some of the pages, especially if the parts are manufactured, or become, slightly out of alignment.

Moreover, if the rings of a conventional ring mechanism are broken or damaged, changing the ring mechanism is possible normally only if the ring binder can be returned to the manufacturer.

Furthermore, conventional ring binders are generally each limited to a particular number of rings at particular spacing. One standard arrangement is two rings at 80 mm. spacing, another is three rings at 108 mm. spacing, whilst a third is four rings at 80 mm. spacing. It would be desirable to have a ring binder which could cope with, say, all three of the corresponding sheet hole numbers and spacings.

According to one aspect of the present invention, there is provided a ring binding apparatus comprising a guide, a guided slide carried by said guide for linearly slidingly guided movement relative to said guide between a first position and a second position, a detent arrangement whereby said guided slide is releasably retained in said second position relative to said guide, and a plurality of loop-form elements receivable between said guide and said guided slide in said first position and, when said guided slide is in said second position relative to said guide, locatingly engaged by said guided slide in positions transverse to said linearly slidingly guided movement and parallel to each other.

According to a second aspect of the present invention, there is provided a ring binding apparatus comprising a plurality of loop-form elements, and a releasable retaining arrangement serving releasably to retain said elements in positions in a row and substantially parallel to each other transversely of said row, said elements being removable independently of each other following release of said retaining arrangement

According to a third aspect of the present invention, there is provided a method of mounting sheets in a ring binding apparatus, comprising aligning from sheet-to-sheet lateral binding holes therethrough, inserting independently of each other a plurality of loop-form binding elements through respective groups of said holes aligned with each other, and engagingly locating said elements in a row and substantially parallel to each other and transversely to said row.

Owing to these aspects of the invention, it is possible to arrange for each individual loop-form element to be replaceable by an identical element in the event of damage thereto and/or for each loop-form element to be an open loop engagingly locatable at its respective ends whereby, once the element has been anchored at both ends, a perforated sheet retained by the element cannot escape therefrom except by tearing of the sheet and/or for retention and release of all of the elements simultaneously.

Furthermore, it is possible for one-and-the-same ring binding apparatus to be able to cope with various sheet hole numbers and spacings.

In order that the invention may be clearly and completely disclosed, reference will now be made, by way of example, to the accompanying drawings, in which:—

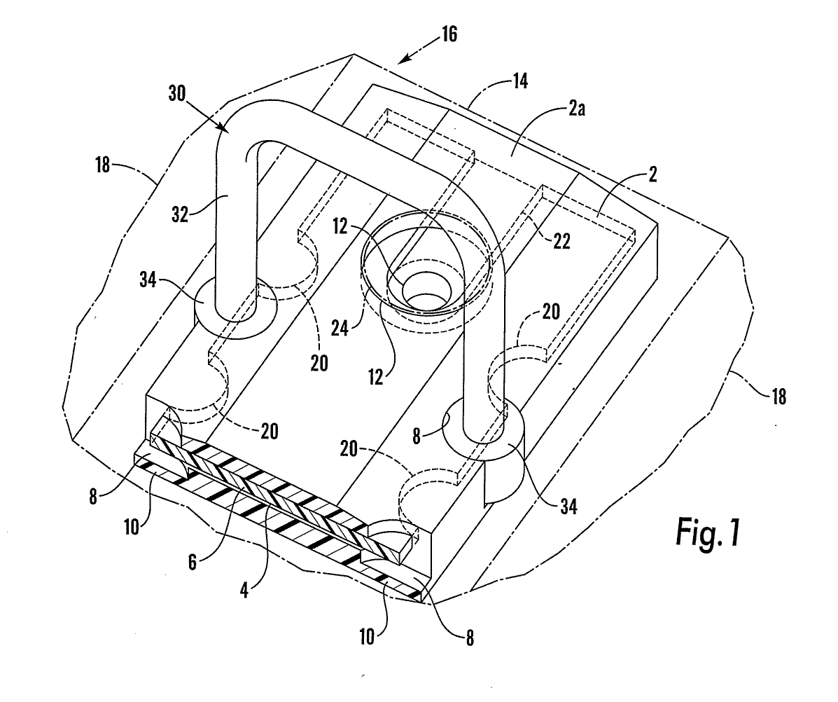

FIG. 1 is a diagrammatic, fragmentary, perspective view from above of an end portion of a ring binding apparatus, with an adjacent portion of a cover being shown in dot-dash lines,

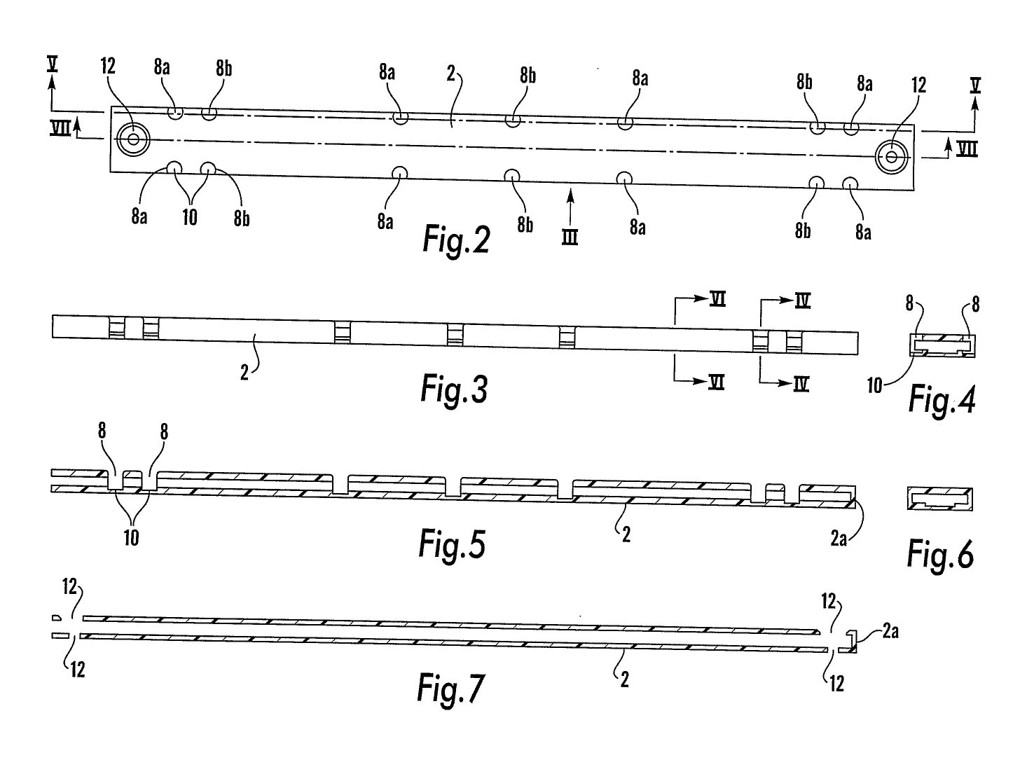

FIG. 2 is a top plan view of a hollow, elongate guide of the apparatus,

FIG. 3 is a side elevation of the guide taken in the direction of the arrow III in FIG. 2,

FIG. 4 is a transverse cross-section taken on the line IV-IV of FIG. 3,

FIG. 5 is a longitudinal vertical section taken on the line V-V in FIG. 2,

FIG. 6 is a transverse cross-section taken on the line VI-VI of FIG. 3,

FIG. 7 is a vertical longitudinal central section taken on the line VII-VII of FIG. 2,

FIG. 8 is a top plan view of a guided slide of the apparatus,

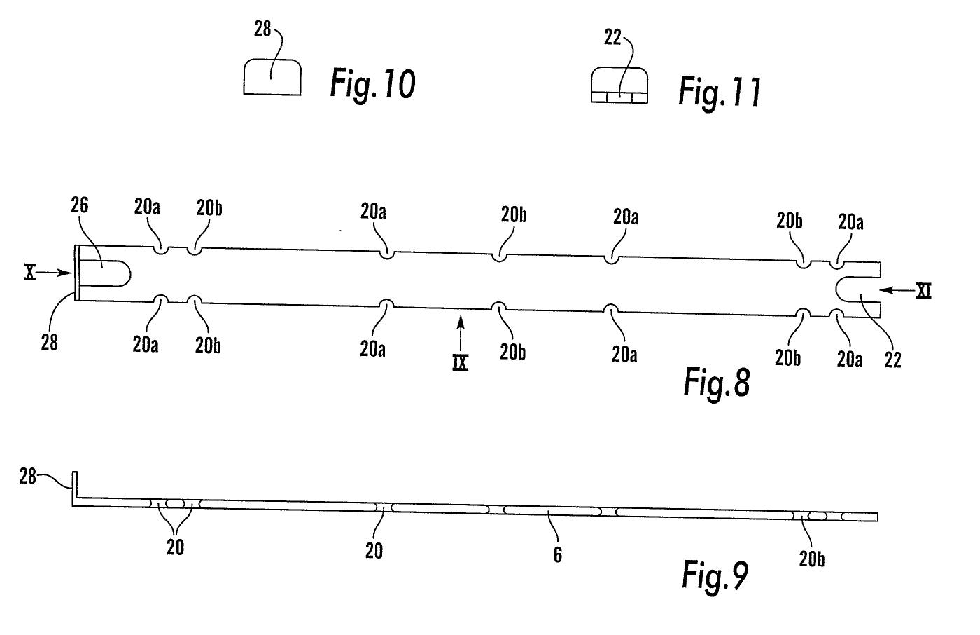

FIG. 9 is a side elevation taken in the direction of the arrow IX in FIG. 8,

FIG. 10 is an end elevation taken in the direction of the arrow X in FIG. 8,

FIG. 11 is an end elevation taken in the direction of the arrow XI in FIG. 8,

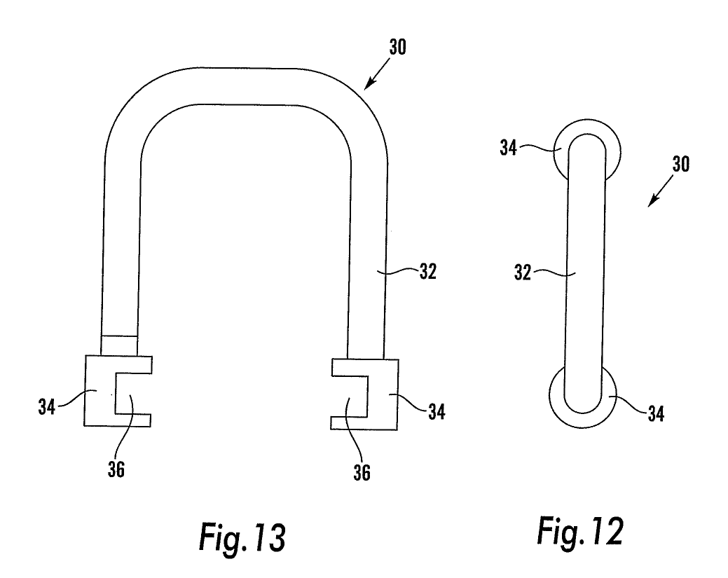

FIG. 12 is a top plan view of a loop-form binding element of one of a plurality of identical binding elements of the apparatus,

FIG. 13 is an elevation of the element of FIG. 12,

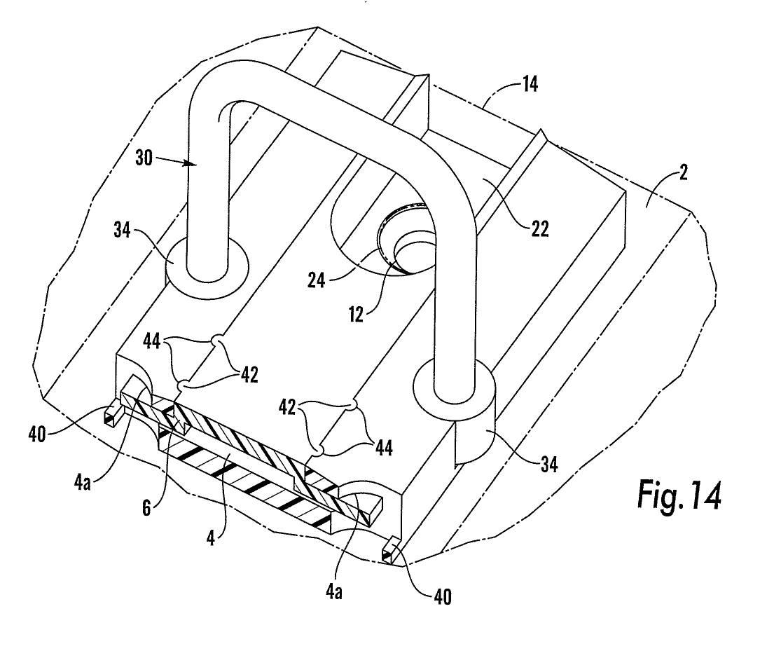

FIG. 14 is a view similar to FIG. 1, but of a modified version of the apparatus,

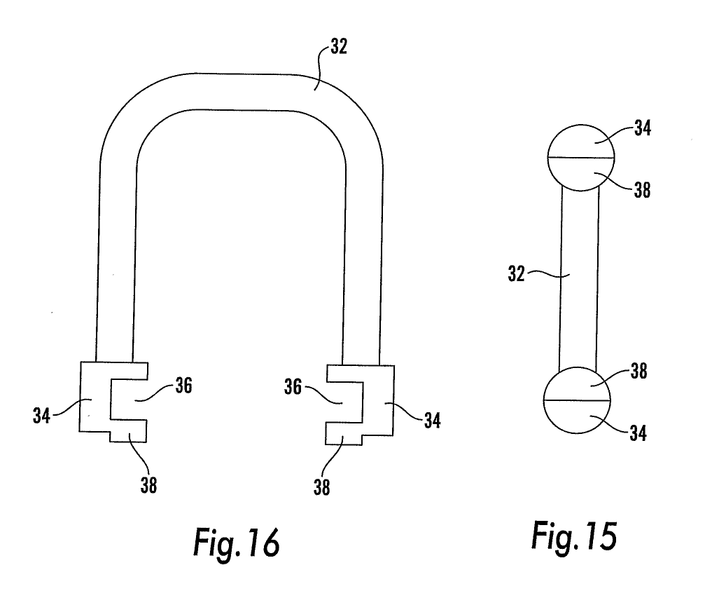

FIG. 15 is an underneath plan view of one of the loop-form binding elements of the modified version, and

FIG. 16 is an end elevation of the element of FIG. 15.

Referring to FIGS. 1 to 13, the ring binding apparatus comprises a channel-form guide 2 whereof the interior has a slot 4 which receives a slide 6 in the basic form of a rectangular strip. The guide 2 is generally in the form of a rectangular strip with the slot 4 formed therealong and closed at its end 2a. Formed in respective opposite external longitudinal edges of the guide 2 are respective recesses 8 of each of a plurality of pairs of recesses, as viewed in top plan. Each recess is part circular-cylindrical, has a vertical axis and, as viewed in top plan, extends through more than 180°. Each has a floor 10 and is open upwardly and laterally, outwardly, as well as laterally inwardly where it intersects the slot 4. The pairs of recesses 8 are located at longitudinal spacings conventional for rings of ring binders.

There are four pairs of recesses 8a spaced apart by a standard 80 mm. and three pairs of recesses 8b spaced apart by a standard 108 mm. At each end zone, the guide 2 is formed with rivet holes 12 through its upper and lower walls whereby the apparatus can be fastened to the spine 14 of a ring binder cover 16 having front and rear sheets 18. The slide 6 is formed, in its respective opposite edge faces, with recesses 20 each of part circular-cylindrical form with a vertical axis and open upwards, downwards and laterally outwardly. The recesses 20 are arranged in pairs at spacings along the slide 6 identical to those of the pairs of recesses 8 along the guide 2. Thus, there are four pairs of recesses 20a spaced apart by a standard 80 mm. and three pairs of recesses 20b spaced apart by a standard 108 mm. However, when the slide 6 has been fully inserted into the guide 2, the pairs of recesses 20 are spaced slightly inwards longitudinally from the corresponding pairs of recesses 8. The inner end of the slide 6 is formed with a U-shaped recess 22 to take account of the presence of the rivet 24 diagrammatically indicated by dot-dash lines in FIG. 1. The outer end of the slide 6 is also formed with a U-shaped recess 26 as seen in plan view, in this case allowing limited longitudinal movement of the slide 6 relative to the guide 2. The slide 6 has at its very outer end an integral finger tab 28 whereby the slide 6 can be moved longitudinally relative to the guide 2 into and out of element-retaining and element-releasing positions. Each element, of which one, referenced 30, is illustrated in FIGS. 12 and 13, consists of a U-shaped part 32 with heads 34 of circular-cylindrical outline integral and co-axial with the ends of the U-shaped part 32. Each head 34 is of a diameter to be received slidingly in any one of the recesses 8 and thus any one of the recesses 20 and is formed, transversely of its axis, with a semi-cylindrical, inwardly facing slot 36 which can slidingly receive a longitudinal edge of the slide 6.

To mount the guide 2, and therewith a slide 6, on the spine 14, the slide 6 is substantially fully inserted into the guide 2 and then the rivets (24) are passed through the holes 12 and are fastened so as to fix the guide 2 to the spine 14. The customer purchases the ring binder in that form, with the elements 30 being sold with the binder but not yet in position on the guide 2. To mount sheets into the ring binder, with the recesses 20 vertically aligned with the corresponding recesses 8, the user aligns the conventional perforations of the sheets with the upper ends of the recesses 8 at one longitudinal edge of the guide 2. He then takes each of the elements 30 in turn and inserts one of its heads 34 downwardly through each group of aligned perforations into the corresponding recess 8 at the relevant longitudinal edge of the guide 2, whilst at the same time inserting the other head 34 of the element 30 downwardly through the other recess 8 of the pair at the opposite longitudinal edge of the guide 2. By pressing on the tab 28, he then shifts the recesses 20 longitudinally inwardly, so that the immediately following edge portions of the longitudinal edges of the slide 6 come to extend through the slots 36 and so anchor the heads 34 and thus the elements 30 in position. Even if the elements 30 are semi-flexible, the heads 34 are prevented from moving laterally outwardly by virtue of being laterally outwardly embraced by the wall surfaces of the recesses 8. Moreover, the floors 10 facilitate aligning of the slots 36 with the longitudinal edge portions of the slide 6. The slide 6 may be releasably held in its element-retaining position relative to the guide 2 by being a friction fit therein or by some releasable holding means.

The version shown in FIGS. 14 to 16 differs from that shown in FIGS. 1 to 13 in two main respects. Firstly, instead of relying upon embracing of the heads 34 by the wall surfaces of the recesses 8 to prevent the heads 34 from moving laterally outwards, each head 34 is provided on the inner side of its base with an integral, semi-cylindrical lug 38 which, towards the end of downward insertion of the head 34 into the recess 8, comes to be received in a semi-circularly shaped hole through the floor 10. Thus, each floor 10, is, in effect, replaced by a bar 40 which serves both to obstruct laterally outward movement of the lug 38 (and thus of the head 34) and to locate the head 34 and thus its slot 36 into alignment with the relevant longitudinal edge portion of the slide 6. Secondly, the slide 6 is of a “top-hat” cross-section, whilst the slot 4 is open at the top throughout its length and has undercuts 4a receiving the respective longitudinal edge portions of the slide 6, whereby, instead of the rivets each extending through a hole 12 in an upper wall of the guide 2 and a hole 12 in the lower wall thereof, there is provided for each rivet simply a hole 12 in the lower wall of the guide 2 readily accessible through the U-shaped slots (22 and 24) in the respective ends of the slide 6. Thus, the slide 6 can be fully withdrawn from the guide 2 by the customer without any need to remove the longitudinally outer rivet. The configuration of the slot 4 and the slide 6 in this version facilitates the provision of a detent arrangement for preventing undesired movement of the slide 6 along the guide 2. In this version, rounded detents 42 provided on respective opposite longitudinal edges of the upper part of the slide 6 releasably engage in rounded notches 44 in the facing upper wall surfaces of the slot 4.

The versions of the apparatus described with reference to the drawings have the advantage that the “ring” elements 30 are continuous and so, with their heads 34 securely anchored, presentation material cannot fall from the elements unless the material itself (including perforated sleeves) tears. Moreover, the apparatus can be used in a standard two-three-or four-ring configuration, as desired, since the elements 30 are removable and replaceable in different numbers and spacings. Furthermore, if one of the elements 30 were to be broken or become missing, the user can simply order and mount a replacement element. Furthermore, the elements can be locked relatively flushly into the base provided by the items 2 and 6. Furthermore, since each element is continuous, turning of the presentation material is easier than with two-part rings.

1-29. (canceled)

30. A ring binding apparatus comprising a guide, a guided slide carried by said guide for linearly slidingly guided movement relative to said guide between a first position and a second position, a detent arrangement whereby said guided slide is releasably retained in said second position relative to said guide, and a plurality of loop-form elements receivable between said guide and said guided slide in said first position and, when said guided slide is in said second position relative to said guide, locatingly engaged by said guided, slide in positions transverse to said linearly slidingly guided movement and parallel to each other.

31. An apparatus according to claim 30, wherein, with said elements locatingly engaged by said slide as aforesaid, said elements are removable independently of each other once said first position has been again attained.

32. An apparatus according to claim 30, wherein said guide is generally in the form of a rectangular strip extending in a plane and is of channel form whereof the interior has longitudinally a slot which receives said slide, which is basically a rectangular strip.

33. An apparatus according to claim 32, wherein, as viewed perpendicularly to said plane, respective recesses of each of a plurality of spaced-apart pairs of recesses are formed in respective opposite external longitudinal edges of said guide and intersect said slot, and respective recesses of each of a plurality of correspondingly spaced-apart pairs of recesses are formed in respective opposite edges of said slide, relative sliding movement of said slide and said guide into said first position bringing recesses of said pairs of recesses in said guide into alignment with recesses in said pairs of recesses in said slide so that end portions of said loop-form elements may be inserted therein, said end portions being formed with respective inwardly facing slots therein whereby relative movement of said guide and said slide into said second position causes said respective opposite edges of said slide to anchor said end portions.

34. An apparatus according to claim 33, wherein, as viewed perpendicularly to said plane, each recess in said guide is part circular cylindrical and extends through more than 180°.

35. An apparatus according to claim 34, wherein the recesses in said guide have respective floors limiting depth of insertion of said end portions therein.

36. An apparatus according to claim 35, wherein each of said floors is formed with a hole therein and each of said end portions is formed longitudinally thereof at its free extremity with a lug receivable in said hole.

37. An apparatus according to of claim 33, wherein, as viewed perpendicularly to said plane, each recess in said slide is part cylindrical.

38. An apparatus according to claim 33, wherein said pairs of recesses in said guide comprise four pairs spaced apart by 80 mm. and three pairs spaced apart by 108 mm.

39. An apparatus according to claim 30, wherein said guide has fixing holes therethrough whereby fixing members can attach said guide to a support.

40. An apparatus according to claim 39, wherein said slide is of top-hat cross-section to avoid interference between said slide and said fixing members during sliding of said slide relative to said guide.

41. An apparatus according to claim 30, wherein each of said elements is U-shaped with headed end portions.

42. An apparatus according to claim 30, wherein said detent arrangement comprises at least one rounded detent projecting from one of said guide and said slide and at least one co-operating notch formed in the other of said guide and said slide.

43. A ring binding apparatus comprising a plurality of loop-form elements, and a releasable retaining arrangement serving releasably to retain said elements in positions in a row and substantially parallel to each other transversely of said row, said elements being removable independently of each other following release of said retaining arrangement.

44. An apparatus according to claim 43, wherein said retaining arrangement comprises a guide and a slide slidingly guided thereby.

45. An apparatus according to claim 44, wherein said guide is of channel form whereof the interior has longitudinally a slot which receives said slide, which is basically a rectangular strip.

46. An apparatus according to claim 45, wherein, as viewed perpendicularly to said plane, respective recesses of each of a plurality of spaced-apart pairs of recesses are formed in respective opposite external longitudinal edges of said guide and intersect said slot, and respective recesses of each of a plurality of correspondingly spaced-apart pairs of recesses are formed in respective opposite edges of said slide, relative sliding movement of said slide and said guide into said first position bringing recesses of said pairs of recesses in said guide into alignment with recesses in said pairs of recesses in said slide so that end portions of said loop-form elements may be inserted therein, said end portions being formed with respective inwardly facing slots therein whereby relative movement of said guide and said slide into said second position causes said respective opposite edges of said slide to anchor said end portions.

47. An apparatus according to claim 43, wherein each of said elements is U-shaped with headed end portions.

48. A method of mounting sheets in a ring binding apparatus, comprising aligning from sheet-to-sheet lateral binding holes therethrough, inserting independently of each other a plurality of loop-form binding elements through respective groups of said holes aligned with each other, and engagingly locating said elements in a row and substantially parallel to each other and transversely to said row.

49. A method according to claim 48, wherein said engagingly locating comprises inserting end portions of each of said elements between a guide and a slide, and sliding said slide relative to said guide to trap those end portions therebetween.
